(19) United States
(12) Patent Application Publication
(10) Pub. No.: US 2014/0080012 A1
(43) Pub. Date: Mar. 20, 2014

(54) ELECTROLYTE FOR METAL-AIR BATTERY AND METAL-AIR BATTERY

(71) Applicants: Keiichi MINAMI, Susono-shi (JP); Yasutoshi HOUJYOU, Numazu-shi (JP)

(72) Inventors: Keiichi MINAMI, Susono-shi (JP); Yasutoshi HOUJYOU, Numazu-shi (JP)

(73) Assignee: TOYOTA JIDOSHA KABUSHIKI KAISHA, Toyota-shi (JP)

(21) Appl. No.: 14/024,745

(22) Filed: Sep. 12, 2013

(30) Foreign Application Priority Data
Sep. 14, 2012 (JP) 2012-203072

(51) Int. Cl. H01M 12/02; H01M 12/08

(52) U.S. Cl. CPC H01M 12/02; H01M 12/08
USPC 429/403; 429/498

(57) ABSTRACT

An electrolyte for a metal-air battery that contains 10 to 80% by mass of methyl difluoroacetate.

### INCORPORATION BY REFERENCE

The disclosure of Japanese Patent Application No, 2012-203072 filed on Sep. 14, 2012 including the specification, drawings and abstract is incorporated herein by reference in its entirety.

### BACKGROUND OF THE INVENTION

1. Field of the Invention

The present invention relates to an electrolyte for use in a metal-air battery and to a metal-air battery.

2. Description of Related Art

Recent spread and progress of cellular phones and so on has generated an increasing demand for higher capacity batteries as power sources therefor. In such a circumstance, metal-air batteries, which can be charged and discharged because oxidation and reduction reactions of oxygen occurs at the air electrode using oxygen from the atmosphere as a positive electrode active material and oxidation and reduction reactions of a metal occur at the negative electrode, have a high energy density and draw attention as high-capacity batteries that surpass lithium-ion batteries, which are currently used widely (National Institute of Advanced Industrial Science and Technology, “Development of New-type Lithium-Air Battery with Large Capacity,” [online], press released on Feb. 24, 2009, [retrieved on Aug. 19, 2011], the Internet <http://www.aist.go.jp/aist_j/press_release/pr2009/pr20090224/pr20090224.html>).

Organic solvents are conventionally used as the non-aqueous electrolytes for metal-air batteries. However, organic solvents are volatile and miscible with water and therefore may have a problem with stability when the metal-air batteries are operated for a long period of time. There is a possibility that volatilization of the electrolytic solution from the positive electrode (air electrode) side may cause an increase in battery resistance or ingress of moisture into the battery may cause corrosion of the metal lithium as the negative electrode when the metal-air batteries are operated for a long period of time. These phenomena can impair the feature of air batteries, long-term discharge.

For the purpose of providing a lithium air battery that can operate stably for a long period time by preventing the decrease of electrolytic solution by volatilization and the ingress of moisture into the battery, an air battery is proposed in which an ionic liquid, such as N-methyl-N-propylpiperidinium bis(trifluoromethanesulfonyl)amide (abbreviation: PP13TFSA), is used as the non-aqueous electrolyte (Japanese Patent Application Publication No. 2011-14478 (JP 2011-14478 A)). An ionic liquid means a substance which consists only of ionic molecules which are a combination of a cation and an anion and is liquid at normal temperature (15° C. to 25° C.).

The use of an ionic liquid, such as N-methyl-N-propylpiperidinium bis(trifluoromethanesulfonyl)amide (PP13TFSA), as the electrolyte for an air battery is effective to a certain degree in preventing the decrease of electrolytic solution by volatilization and the ingress of moisture into the battery. However, air batteries in which an ionic liquid, such as PP13TFSA, is used as the electrolyte are not still necessarily satisfactory in terms of output as batteries. Thus, an electrolyte that can further improve the output of metal-air batteries is desired.

### SUMMARY OF THE INVENTION

An electrolyte for a metal-air battery according to an embodiment of the present invention contains 10 to 80% by mass of methyl difluoroacetate.

According to the electrolyte for a metal-air battery according to the above aspect, an electrolyte that can improve the output characteristics of metal-air batteries is provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a cross-sectional schematic view of an example of an electrochemical cell that includes an electrolyte according to the present invention, and

FIG. 2 is a graph that shows the relationship between the content of methyl difluoroacetate in the electrolyte and the maximum current density of electrochemical cells.

### DETAILED DESCRIPTION OF EMBODIMENTS

An electrolyte for a metal-air battery according to one embodiment of the present invention contains 10 to 80% by mass of methyl difluoroacetate.

In a conventional metal-air battery, the outermost surface of the negative electrode metal may directly contact the electrolyte when the negative electrode metal is eluted during discharge. The outermost surface of the negative electrode metal is highly active and therefore easily forms a resistance layer. Once a resistance layer is formed, it leads to an increase in battery resistance and therefore causes a decrease in the output of the metal-air battery.

The present inventors found that the increase in interfacial resistance at the negative electrode can be prevented and the output performance of a metal-air battery can be improved when 10 to 80% by mass of methyl difluoroacetate is added to the electrolyte to improve the output of the metal-air battery.

Oxygen is necessary for the battery reaction in a metal-air battery, and it is therefore believed that the oxygen concentration in the electrolyte is saturated. It is also believed that methyl difluoroacetate is preferentially bonded to oxygen because methyl difluoroacetate dissolves a large amount of oxygen.

In order to prevent an increase in interfacial resistance at the negative electrode, it is believed effective to form a stable interface layer on a surface of the negative electrode. In order to form a stable interface layer on a surface of the negative electrode in a metal-air battery, it was found effective to add a large amount of methyl difluoroacetate to the electrolyte in view of the fact that methyl difluoroacetate is preferentially bonded to oxygen.

The content of methyl difluoroacetate in the electrolyte is 10 to 90% by mass. The lower limit of the content of methyl difluoroacetate is preferably 30% by mass or higher, more preferably 40% by mass or higher, even more preferably 50% by mass or higher. The upper limit of the content of methyl difluoroacetate is preferably 80% by mass or lower, more preferably 70% by mass or lower, even more preferably 60% by mass or lower. When the content of methyl difluoroacetate is in any of the above ranges, the output characteristics of the metal-air battery can be improved and a methyl difluoroacetate content of, for example, 10 to 80% by mass, 30 to 80% by mass, 40 to 80% by mass or 50 to 80% by mass can be achieved.

The electrolyte according to one embodiment of the present invention can be used to constitute a metal-air battery. A metal-air battery that is constituted using the electrolyte according to one embodiment of the present invention may include a positive electrode layer, a negative electrode layer, and an electrolyte layer that is interposed between the positive electrode layer and the negative electrode layer.

The positive electrode layer may contain an electrically-conductive material. Preferred examples of electrically-conductive material include, but are not limited to, porous materials. Examples of the porous materials include carbon materials such as carbon including carbon blacks such as Ketjen black, acetylene black, channel black, furnace black and mesoporous carbon, activated carbon and carbon fibers. The use of a carbon material with a large specific surface area is preferred. A porous material with a pore volume in a nanometer order, such as 1 mL/g, is also preferred. Preferably, the electrically-conductive material constitutes 10 to 99% by mass of the positive electrode layer.

The positive electrode layer may contain a binder. Examples of binders that can be used include fluorine resins such as polytetrafluoroethylene (PTFE), polyvinylidene fluoride (PVdF) and fluorine rubber, thermoplastic resins such as polypropylene, polyethylene and polyacrylonitrile, and styrene-butadiene rubber (SBR). Preferably, the binder constitutes 1 to 40% by mass of the positive electrode layer.

The positive electrode layer may contain an oxidation-reduction catalyst. Examples of the oxidation-reduction catalyst include metal oxides such as manganese dioxide, cobalt oxide and cerium oxide, noble metals such as Pt, Pd, Au and Ag, transition metals such as Co, metal phthalocyanines such as cobalt phthalocyanine, and organic materials such as Fe porphyrin. Preferably, the oxidation-reduction catalyst constitutes 1 to 90% by mass of the positive electrode layer.

In the metal-air battery that is constituted using the electrolyte according to one embodiment of the present invention, the electrolyte layer conducts metal ions between the positive electrode layer and the negative electrode layer, and contains an electrolyte that contains methyl difluoroacetate. The electrolyte may be a liquid electrolyte, gel electrolyte, polymer electrolyte or a combination thereof as long as it contains methyl difluoroacetate. The electrolyte can infiltrate into the fine pores in the above positive electrode layer and fill at least some of the fine pores in the positive electrode layer.

The liquid electrolyte is an electrolyte which contains methyl difluoroacetate and allows exchange of metal ions between the positive electrode layer and the negative electrode layer. An aprotic organic solvent or ionic liquid can be used together with methyl difluoroacetate as the liquid electrolyte.

Examples of the organic solvent include propylene carbonate, ethylene carbonate, diethyl carbonate, dimethyl carbonate, ethylmethyl carbonate, 1,2-dimethoxyethane, 1,2-diethoxyethane, acetonitrile, propionitrile, tetrahydrofuran, 2-methyltetrahydrofuran, dioxane, 1,3-dioxolan, nitromethane, N,N-dimethylformamide, dimethylsulfoxide, sulfolane, γ-butyrolactone and glymes.

The ionic liquid is preferably an ionic liquid which has sufficiently high resistance to oxygen radicals to prevent side reactions. Examples of the ionic liquid include N-methyl-N-propylpiperidinium bis(trifluoromethanesulfonyl)amide (PP13TFSA) and N,N-diethyl-N-methyl-N-(2-methoxyethyl)ammonium bis(trifluoromethanesulfonyl)amide (DEMETFSA).

An electrolytic solution which is a combination of any of the above ionic liquids and organic solvents with methyl difluoroacetate may be used as the liquid electrolyte.

A supporting electrolyte may be dissolved in the liquid electrolyte. As the supporting electrolyte, a salt of lithium ions and any of the following anions can be used: halide anions such as Cl⁻, Br⁻, and I⁻; boride anions such as BF₄⁻, B(CN)₄− and B(C₂O₄)₂⁻; amide anions or imide anions such as (CN)₂N⁻, [N(CF₃)₂]⁻ and [N(SO₂CF₃)₂]⁻; sulfate anions or sulfonate anions such as RSO₃− wherein R represents an aliphatic hydrocarbon group or aromatic hydrocarbon group (the same applies hereinafter), RSO₄⁻, R^{f}SO₃⁻ wherein R^{f} represents a fluorine-containing halogenated hydrocarbon group (the same applies hereinafter) and R^{f}SO₄⁻; phosphorus-containing anions such as R^{f}₂P(O)O⁻, PF₆⁻and R^{f}₃PF₃⁻; antimony-containing anion such as SbF₆; and anions such as lactate, nitric acid ions, trifluoroacetate and tris(trifluoromethanesulfonyl)methide. Examples include LiPF₆, LiBF₄, lithium bis(trifluoromethanesulfonyl)amide (LiN(CF₃SO₂)₂, which is hereinafter referred to as “LiTFSA”), LiCF₃SO₃, LiC₄F₉SO₃, LiC(CF₃SO₂)₃ and LiClO₄. The use of LiTFSA is preferred. These supporting electrolytes may be used in combination of two or more. The amount of supporting electrolyte added relative to the electrolyte is not specifically limited but is preferably approximately 0.1 to 1 mol/kg.

The polymer electrolyte is a polymer electrolyte which can be used in conjunction with methyl difluoroacetate and preferably contains a lithium salt and a polymer. The lithium salt is not specifically limited as long as it is a lithium salt that is commonly used in lithium air batteries. Examples of the lithium salt include the lithium salts that are listed as lithium salts that can be used as a supporting electrolyte. The polymer is not specifically limited as long as it can form a complex with the lithium salt. Examples of the polymer include polyethylene oxide.

The gel electrolyte is a gel electrolyte which can be used in conjunction with methyl difluoroacetate and preferably contains a lithium salt, a polymer and a non-aqueous solvent. Any of the lithium salts that are listed above may be used as the lithium salt. The non-aqueous solvent is not specifically limited as long as is can dissolve the lithium salt. For example, the non-aqueous solvent may be methyl difluoroacetate or any of the organic solvents or ionic liquids as described above. These non-aqueous solvents may be used singly or in the form of a mixture of two or more. The polymer is not specifically limited as long as it can gelate. Examples of the polymer include polyethylene oxide, polypropylene oxide, polyacrylnitrile, polyvinylidene fluoride (PVdF), polyurethane, polyacrylate and cellulose.

The metal-air battery that is constituted using the electrolyte according to the present invention may have a separator between the positive electrode layer and the negative electrode layer. The separator is not specifically limit. For example, a polymeric non-woven fabric, such as polypropylene non-woven fabric or polyphenylene sulfide non-woven fabric, a microporous film of an olefin resin, such as polyethylene or polypropylene, or a combination thereof may be used. The electrolyte layer may be formed by impregnating the separator with an electrolyte, such as a liquid electrolyte.

The negative electrode layer which is included in the metal-air battery that is constituted using the electrolyte according to one embodiment of the present invention is a layer which contains a negative electrode active material that contains a metal. As the negative electrode active material, a metal, alloy material or carbon material, for example, can be used. Examples of the negative electrode active material include alkaline metals such as lithium, sodium and potassium, alkaline-earth metals such as magnesium and calcium, group 13 elements such as aluminum, transition metals such as zinc, iron and silver, alloy materials that contain any of these metals or materials that contain any of these metals, carbon materials such as graphite, and other anode materials that can be used in lithium-ion batteries and so on.

When a material that contains lithium is used as the negative electrode active material, a lithium-containing carbonaceous material, an alloy that contains a lithium element, or oxide, nitride or sulfide of lithium may be used as the material that contains lithium. Examples of the alloy that contains a lithium element include lithium-aluminum alloys, lithium-tin alloys, lithium-lead alloys and lithium-silicon alloys. Examples of metal oxide that contains a lithium element include lithium titanium oxide. Examples of metal nitride that contains a lithium element include lithium cobalt nitride, lithium iron nitride and lithium manganese nitride.

The negative electrode layer may further contain an electrically-conductive material and/or a binder. For example, when the negative electrode active material is in the form of a foil, the negative electrode layer may be composed only of the negative electrode active material. When the negative electrode active material is in the form of a powder, the negative electrode layer may be composed of the negative electrode active material and a binder. The electrically-conductive material and the binder may be the same as those for use in the positive electrode layer.

Any material that is usually used as an exterior material for an air battery, such as a metal can, resin or laminate package, can be used as the exterior material for the metal-air battery that is constituted using the electrolyte according to one embodiment of the present invention.

The exterior material may have holes through which oxygen is supplied at any locations. For example, the exterior material may have holes that extend to the surface of the positive electrode layer in contact with air. The oxygen source is preferably dry air or pure oxygen.

The metal-air battery that is constituted using the electrolyte according to one embodiment of the present invention may include an oxygen permeation membrane. The oxygen permeation membrane may be provided on the positive electrode layer on the side opposite the electrolyte layer and in contact with air. As the oxygen permeation membrane, a water-repellent porous membrane which allows oxygen in the air to pass through and can prevent ingress of moisture, for example, can be used. For example, a porous membrane of polyester or polyphenylene sulfide may be used. A water-repellent membrane may be separately provided.

A positive electrode current collector may be disposed adjacent to the positive electrode layer. The positive electrode current collector is usually provided on the positive electrode layer on the side opposite the electrolyte layer and in contact with air. An additional positive electrode current collector may be provided between the positive electrode layer and the electrolyte layer. As the positive electrode current collector, any material that is conventionally used as a current collector, such as a carbon paper, a porous structure such as metal mesh, a net-like structure, fibers or a non-woven fabric, can be used without particular imitation. For example, a metal mesh formed of SUS, nickel, aluminum, iron or titanium may be used. A metal foil which has oxygen supply holes may be used as the positive electrode current collector.

A negative electrode current collector may be disposed adjacent to the negative electrode layer. Any material that is conventionally used as a negative electrode current collector, such as an electrically-conductive porous substrate or non-porous metal foil, can be used as the negative electrode current collector without particular imitation. For example, a metal foil of copper, SUS, nickel or the like can be used.

The shape of the metal-air battery that is constituted using the electrolyte according to one embodiment of the present invention is not specifically limited as long as it has oxygen intake holes. The metal-air battery may be of any desired shape, such as cylindrical, cubic, button-like, coin-like or flat.

The metal-air battery that is constituted using the electrolyte according to one embodiment of the present invention can be used as a secondary battery and may be used as a primary battery.

The positive electrode layer and the negative electrode layer in the metal-air battery that is constituted using the electrolyte according to one embodiment of the present invention can be formed by any conventionally used method. For example, when a positive electrode layer that contains carbon particles and a binder is formed, the positive electrode layer can be formed by mixing prescribed amounts of carbon particles and a binder with an appropriate amount of a solvent, such as ethanol, rolling out the mixture to a prescribed thickness, and drying and cutting the rolled mixture. Then, a positive electrode current collector is attached by pressure bonding to the positive electrode layer and the resulting laminate is dried by heating under vacuum, whereby a positive electrode layer that is combined with a current collector can be obtained.

The positive electrode layer can be also obtained by mixing prescribed amounts of carbon particles and a binder with an appropriate amount of a solvent to form a slurry, applying the slurry to a base material and drying the slurry. The obtained positive electrode layer may be subjected to press molding as desired. As the solvent that is used to obtain the slurry, a solvent with a boiling point of not higher than 200° C., such as acetone or NMP, can be used. Examples of the process that can be used to apply the slurry to the base material of positive electrode layer include a doctor blade method, a gravure-transfer method and an ink-jet method. The base material that is used is not specifically limited, and a current collecting plate that can be used as a current collector, a film-like flexible base material, a hard base material or the like may be used. For example, a base material, such as an SUS foil, a polyethylene terephthalate (PET) film or Teflon (Du Pont, trademark), may be used. The same applies to the method for the formation of the negative electrode layer.

### Example 1

The fabrication of a cell is described. A mixture was obtained by mixing 90% by mass of Ketjen black (ECP-600JD, manufactured by Ketjen Black International Company), 10% by mass of a polytetrafluoroethylene (PTFE) binder (F-104, manufactured by Daikin Industries, Ltd.), and an appropriate amount of ethanol as a solvent. The obtained mixture was rolled out by roll pressing, and the rolled mixture was dried and cut, whereby a positive electrode layer with a diameter of 18 mmφ and a thickness of 130 μm was obtained.

The positive electrode layer and a 100 mesh made of SUS304 (manufactured by The Nilaco Corporation) as a current collector were bonded together by pressure bonding and the resulting laminate was dried by heating under vacuum, whereby the current collector was combined with the positive electrode layer.

Lithium bis(trifluoromethanesulfonyl)amide (abbreviation: LiTFSA, manufactured by Kishida Chemical Co., Ltd.) as a lithium salt was dissolved in N-methyl-N-propylpiperidinium bis(trifluoromethanesulfonyl)amide (PP13TFSA, manufactured by Kanto Chemical, Co., Inc.) as a solvent by stirring the mixture at 25° C. for 12 hours in an Ar atmosphere such that a lithium salt concentration of 0.32 mol/kg was achieved. Then, methyl difluoroacetate was added to and mixed with the solution of LiTFSA in PP13TFSA until the content of methyl difluoroacetate reached 50 wt % at 25° C. in an Ar atmosphere to prepare an electrolytic solution.

A metal lithium foil with a diameter of 22 mmφ and a thickness of 500 μm (manufactured by HONJO METAL CO., LTD.) was prepared as a negative electrode layer, and a SUS304 plate (manufactured by The Nilaco Corporation) with a diameter of 22 mm and a thickness 2 cm as a negative electrode current collector was bonded to a surface of the metal lithium foil.

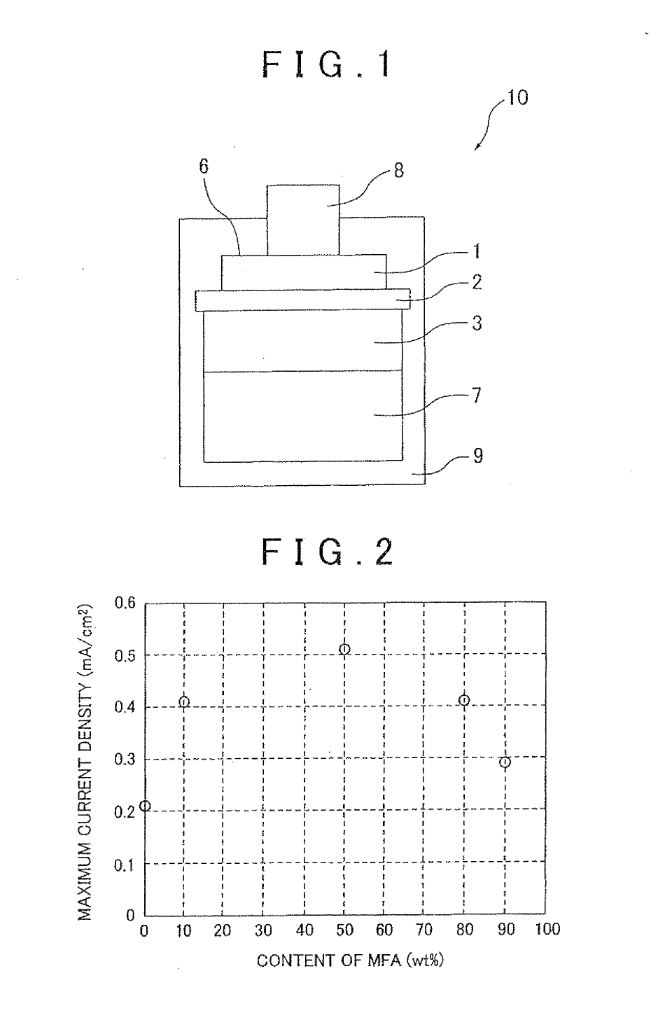

As shown in FIG. 1, the negative electrode current collector 7 and the negative electrode layer 3 were placed with the negative electrode current collector facing down in an SUS airtight container 9 in an Ar atmosphere with an insulating resin interposed therebetween so that the positive electrode layer and the negative electrode layer could be electrically insulated from each other, and a polypropylene non-woven fabric with a thickness of 40 μm and a diameter of 28 mmφ as a separator was placed on the negative electrode layer 3. Then, the separator was impregnated with 100 microliters of the prepared electrolytic solution to form an electrolyte layer 2. Then, the positive electrode (air electrode) layer 1 and the positive electrode current collector 6 were assembled to the separator in such a manner that the electrolytic solution could infiltrate into the voids in the positive electrode layer 1, whereby an electrochemical cell 10 with a gas reservoir part 8 for evaluation was fabricated.

Then, the electrochemical cell 10 was placed in a glass desiccator with a gas replacement cock (500 mL spec), and the atmosphere in the glass desiccator was replaced with an oxygen atmosphere using pure oxygen (Taiyo Nippon Sanso Corporation, 99.9%).

### Example 2

A cell for evaluation was fabricated and placed in a glass desiccator and the atmosphere in the glass desiccator was replaced with an oxygen atmosphere in the same manner as in Example 1 except that methyl difluoroacetate was added to and mixed with the solution of LiTFSA in PP13TFSA until the content of methyl difluoroacetate reached 80 wt % to prepare the electrolytic solution.

### Example 3

A cell for evaluation was fabricated and placed in a glass desiccator and the atmosphere in the glass desiccator was replaced with an oxygen atmosphere in the same manner as in Example 1 except that methyl difluoroacetate was added to and mixed with the solution of LiTFSA in PP13TFSA until the content of methyl difluoroacetate reached 10 wt % to prepare the electrolytic solution.

### Example 4

A cell for evaluation was fabricated and placed in a glass desiccator and the atmosphere in the glass desiccator was replaced with an oxygen atmosphere in the same manner as in Example 1 except that methyl difluoroacetate was added to and mixed with the solution of LiTFSA in PP13TFSA until the content of methyl difluoroacetate reached 90 wt % to prepare the electrolytic solution.

### Comparative Example 1

A cell for evaluation was fabricated and placed in a glass desiccator and the atmosphere in the glass desiccator was replaced with an oxygen atmosphere in the same manner as in Example 1 except that the solution of LiTFSA in PP13TFSA, to which no methyl difluoroacetate was added, was used as the electrolytic solution.

The interfacial resistances at the negative electrode of the cells for evaluation that were fabricated and placed in a glass desiccator in Example 1 and Comparative Example 1 was measured by an AC impedance method. The AC impedance method was carried out by measuring the impedance of the metal-air battery at 60° C. and an amplitude of 10 mV in a frequency range of 2 MHz to 0.1 Hz. Then, Cole-Cole plots were drawn and the difference between the resistance component at the left end of the arc and the resistance component at the right end of the arc was calculated as the interfacial resistance at the negative electrode.

Table 1 shows the relationship between the content of methyl difluoroacetate in the electrolytic solution and the interfacial resistance at negative electrode of the cells for evaluation that were fabricated and placed in a glass desiccator in Example 1 and Comparative Example 1.

TABLE 1

| | | Interface resistance at |
|---|---|---|
| | | negative electrode (%) |
| | Content of methyl | (Relative to value in |
| | difluoroacetate | Comparative Example 1 |
| | (wt %) | taken as 100%) |
| Example 1 | 50 | 42 |
| Comparative Example 1 | 0 | 100 |

When the interfacial resistance at the negative electrode in the cell for evaluation of Comparative Example 1, which included an electrolytic solution free of methyl difluoroacetate, is taken as 100%, the interfacial resistance at the negative electrode in the cell for evaluation of Example 1, which included an electrolytic solution that contained 50% by mass of methyl difluoroacetate, was 42%.

(Measurement of maximum current density) The cells for evaluation that were fabricated and placed in a glass desiccator in Example 1 to 4 and Comparative Example 1 were allowed to stand still in a constant-temperature bath at 60° C. for 3 hours prior to the start of test. Then, the I-V characteristics were measured with a multi-channel potentiostat/galvanostat VMP3 (manufactured by Bio-Logic) charge-discharge I-V measurement apparatus at 60° C. and in pure oxygen at 1 atmosphere while the current density was gradually increased, and the current density at a cut voltage of 2.3 V was measured as the maximum current density.

FIG. 2 and Table 2 show the relationship between the content of methyl difluoroacetate and the maximum current density of the cells that were fabricated in Examples 1 to 4 and Comparative Example 1.

TABLE 2

| | Content of methyl | Maximum current |
|---|---|---|
| | difluoroacetate (wt %) | density (mA/cm²) |
| Example 1 | 50 | 0.509 |
| Example 2 | 80 | 0.413 |
| Example 3 | 10 | 0.409 |
| Example 4 | 90 | 0.290 |
| Comparative Example 1 | 0 | 0.210 |

Compared to the cell that used an electrolytic solution free of MFA, the cells that used an electrolytic solution that contained 10 wt % or more of MFA exhibited a higher maximum current density, and cells that used an electrolytic solution that contained 50 to 80 wt % of MFA exhibited a particularly high maximum current density.

What is claimed is:

1. An electrolyte for a metal-air battery, containing 10 to 80% by mass of methyl difluoroacetate.

2. The electrolyte for a metal-air battery according to claim 1, containing 30 to 80% by mass of methyl difluoroacetate.

3. The electrolyte for a metal-air battery according to claim 1, containing 50 to 80% by mass of methyl difluoroacetate.

4. The electrolyte for a metal-air battery according to claim 1, containing an ionic liquid and methyl difluoroacetate.

5. The electrolyte for a metal-air battery according to claim 4, wherein the ionic liquid contains N-methyl-N-propylpiperidinium bis(trifluoromethanesulfonyl)amide.

6. The electrolyte for a metal-air battery according to claim 1, containing a lithium-containing metal salt.

7. The electrolyte for a metal-air battery according to claim 6, wherein the lithium-containing metal salt is lithium bis(trifluoromethanesulfonyl)amide.

8. A metal-air battery comprising:
a positive electrode layer,
a negative electrode layer, and
an electrolyte layer that is provided between the positive electrode layer and the negative electrode layer,
wherein the electrolyte layer contains an electrolyte according to claim 1.

9. The metal-air battery according to claim 8, wherein the negative electrode layer contains a material that contains lithium.
